(19) United States
(12) Patent Application Publication
(10) Pub. No.: US 2005/0072281 A1
(43) Pub. Date: Apr. 7, 2005

(54) Cutting unit for an impact cutting device and matrix element therefor

(76) Inventor: Helmut Schuster, Denklingen (DE)

Correspondence Address: SCHNECK & SCHNECK, P.O. BOX 2-E, SAN JOSE, CA, 95109-0005, US

(21) Appl. No.: 10/940,125

(22) Filed: Sep. 14, 2004

(30) Foreign Application Priority Data
Oct. 1, 2003 (DE) DE 103 45 864.6
Aug. 18, 2004 (EP) EP 04 019 642.0

(51) Int. Cl. B23D 21/00

(52) U.S. Cl. 83/178; 83/187; 83/199

(57) ABSTRACT

A cutting unit for an impact cutting device having at least one first and one second matrix element for retaining a workpiece to be processed, wherein at least one of the matrix elements is moveably supported relatively to the other matrix element or the other matrix elements and at least one of the matrix elements comprises a variable cross-section for retaining the workpiece. Further, a matrix element having a variable retaining cross-section for a workpiece is provided.

### TECHNICAL FIELD

The invention refers to a cutting unit, particularly for an impact cutting device for adiabatic separation of workpieces, and a matrix or holding element for such a cutting unit.

### BACKGROUND ART

During high-speed impact cutting a high impulse is imparted to a moveable matrix or holding element being laterally displaced along a stationary matrix by means of the impulse. The workpiece is clamped between the matrix or holding elements in a passage running through the matrixes, wherein the passages cross-sections correspond to the workpiece circumference of the workpiece to be separated. Observations show that the workpiece to be cut can be separated almost without plastic deformations by very short, but heavily acting impulse. In contrast to the stationary matrix the displaceable matrix is thereby displaced by only few tenths of millimeters. Herein it is problematic on the one side to transmit a reproducible impulse of accurate power to the moveable matrix, and on the other side to damp the impulse energy, which has not been transformed into separation energy, in such a manner that the impact cutting device is also applicable for permanent use.

DE 695 19 238 T2 (corresponding to EP 0 833 714 B1) describes an impact machine, in which the workpiece is clamped between a stationary and a moveable matrix. On the stationary matrix rests an impact pin, onto which an impact impulse is transmitted by means of a hydraulically moved piston. It is the object herein to achieve a cutting rate as high as possible, so that for example a high cutting rate for wire nails of a certain length is achieved. In order to achieve the high cutting rate by means of the hydraulically operated piston a particular piston/cylinder arrangement is proposed.

U.S. Pat. No. 4,840,236 suggests a hydraulic pneumatic actuator for transmitting high impulses to a workpiece to be compressed or cut. Besides a cylinder arrangement for high acceleration of the piston also an arrangement for slowing down the piston is proposed.

### SUMMARY OF THE INVENTION

It is an object of the invention to provide a cutting unit, an impact cutting device and a matrix element, which ensure a high separation precision and operational reliability during impact cutting, even if impacts are frequently repeated.

The cross-sectional surface of the matrix elements is usually adapted to the outer contour of the workpiece to be separated, wherein in dependence of tolerances there has to be a clearance between the inner wall of the matrix element and the outer wall of the workpiece. Due to this clearance, particularly as regards longer workpieces, an angular offset of the workpiece supported within the matrix element during the impact phase (impact moment) and movement of the moveable matrix element is caused, so that the cutting area may run slightly inclined in contrast to the original alignment of the workpiece in the matrix elements.

The above object has been met with a tool wherein the moveable matrix element, the stationary supported matrix element, or both matrix elements, have a variable cross-section for retaining a workpiece.

It is particularly advantageous that the cross-section can be reduced in impact direction, so that by reducing the cross-section in impact direction during the impact (preferably the stationary supported matrix element) or during the impact phase (preferably the moveable matrix element) the cross-section is adapted to the actual cross-section of the workpiece. This prevents an angular offset of the surface to the original alignment of the workpiece to be processed. Thus the variable cross-section enables at least in impact direction a real abutting of the matrix element on the outer surface of the workpiece.

A clamping device is advantageously provided, with which the variable cross-section can be reduced before and during imparting the separation impact, so that the workpiece to be separated is retained free of clearance in the matrix element. The clamping may be carried out in the moveable and/or stationary matrix element. In a further embodiment a reset device is provided, with which the clamping of the workpiece caused by means of the clamping device is releasable after separation.

In another embodiment one or both matrix elements are formed of at least two parts, so that a relative movement of the single parts of a matrix element enables an abutting of the same on the outer surface of the workpiece. It is in particular advantageous, if the matrix element is separated at transversely to the impact direction. In contrast to a one-part matrix element, here the cross-sectional area of the at least two-part matrix element takes advantageously into account the tolerance of the workpiece, wherein the height of the separation gap is dimensioned such that it is approximately the difference between the greatest cross-section of the workpiece and the smallest cross-section of the workpiece.

A matrix element having a variable cross-section advantageously comprises inner segments being displaceable against each other, wherein between each two inner segments an elastic element is arranged, which particularly are clamped under bias between the inner segments. Thus the inner segments are separated from each other and a workpiece is released as soon as the clamping of the inner segments is released. At least one of the inner segments is advantageously secured against rotation by means of a rotation protection.

In a further embodiment at least one matrix element comprises a gap with variable gap measurement, which starts at the retaining opening for the workpiece to be separated. An operating device for varying the gap measurement is advantageously provided. The gap measurement is advantageously expandable by means of the operating means and/or the introduction of the workpiece to be processed.

In one embodiment between a moveable matrix element and a supporting structure for the cutting unit, a damping device is arranged between the side opposing to the impact side of the moveable matrix and the supporting structure. This arrangement may also be provided in a matrix element without variable cross-section of the opening for retaining the workpiece. By means of the damping element excessive energy from the impact is damped, if the impact energy could not be transformed into separation energy and heat energy. Thus the propagation of excessive impact energy, which in particular regarding tolerance-afflicted workpieces may greatly vary from impact to impact, is limited to a preferably small region of the cutting tool and the propagation onto a cutting device is widely prevented.

The damping element is advantageously biased in impact direction having a bias advantageously depending on the thickness of the workpiece to be processed. By means of the bias the moveable matrix element does not directly move by initial arrival of the impact element at the top surface of the moveable matrix, but the moveable matrix is initially clamped between the impact element and the base (damping element) with a power up to the level of the bias. Only if the bias is overcome, the moveable matrix element is actuated and the further impact energy is then transformed by adiabatic separation and, where applicable, by further damping by means of the damping element. By clamping the moveable matrix element between impact direction and damping element a stabilizing alignment of the moveable matrix element within the cutting unit is achieved. Particularly when using a moveable matrix element having variable cross-section, the clamping initially causes an abutting of the matrix's inner surfaces (in impact direction) on the outer surface of the workpiece free of clearance, so that chocking of the workpiece is prevented when starting the movement phase of the moveable matrix element.

By providing an adjustable bias at the damping element by means of a biasing device, the clamping power is adaptable depending on the thickness or form of the workpiece to be processed. Advantageously, the bias at the damping element can automatically be set by means of a biasing device, so that an adaptation or optimization of the bias is enabled during the running production process. The biasing device thereby can increase and/or reduce the bias of the damping element. The damping device advantageously comprises an air gap, into which particularly compressed air with given pressure and/or flow rate can be fed.

By means of an annular spring as a damping device the excessive energy is advantageously transformed into heat energy within a very short distance. If additionally or alternatively an air gap is provided as damping device and if compressed air is fed into the air gap, contaminations are discharged from the air gap on the one hand and on the other hand the continuous air flow serves for cooling the cutting unit.

If the moveable matrix is supported in a recess having lateral guiding, the air fed into the air gap also causes the reset of the moveable matrix element. This can be supported in that in the case of the displaced matrix element the air can hardly discharge from the air gap and thus an air pressure is build up which resets the matrix with increased power.

If at least one moveable matrix element is supported in a recess having side boundary walls and if pressurized air is supplied to the side boundary walls, then contaminations are discharged on the one hand and the air cussion serves as air conduction bearing for guiding the moveable matrix element in the recession. If in the moveable matrix element the cross-section of the opening enlarges from the separation rim to the feeding or removing side of the workpiece, then not the whole workpiece held in the matrix has to undergo the lateral acceleration effected during the impact operation. Thus the impulse energy acting on the cutting location increases.

In one embodiment, the impact element transmitting the impulse of the impact unit is releasably coupled to an acceleration unit. Before the impact element impinges on the cutting unit a decoupling between the acceleration unit and the impact element is carried out by a coupling device. By decoupling the operations ‘impacting’ and ‘accelerating’ the impact process and the acceleration process can be optimized independently from each other, wherein, particularly by decoupling the acceleration unit from impacting, this essentially undergoes lower mechanical stress. Further, the acceleration may be interrupted exactly then, when the impact element comprises the impulse required for the workpiece to be processed, so that e.g. the slowing down of the acceleration unit in turn has no effects on the impact element and its impulse. By means of the forceless ‘flight’ of the impact element when approaching the cutting unit also an exact adjustment between the acceleration unit and the cutting unit is not necessary for reproducing a given impact impulse.

A carrier of the acceleration unit advantageously grips into the impact element and carries this at least during the acceleration phase and over the acceleration distance. Via the carrier on the one hand the acceleration power is transmitted to the impact element and on the other hand a secure guiding of the impact element is achieved. The coupling ‘at least’ over an acceleration distance means herein that either the carrier is coupled to the impact element only during the acceleration phase and over the acceleration distance and directly after the acceleration a decoupling takes place. Otherwise a coupling is maintained for another given time and distance after the acceleration, so that the carrier couples to the impact element free of force.

### BRIEF DESCRIPTION OF THE DRAWINGS

FIG. 1A is a schematic front view of an impact cutting machine.

FIG. 1B is a partial view of the impact cutting machine while coupling the hammer.

FIG. 1C is a partial view of the impact cutting machine on the verge of decoupling the hammer.

FIG. 1D is a side view of the impact cutting machine.

FIG. 2 is a schematic cross-sectional top view of a hammer unit.

FIGS. 3A and 3B are cross-sectional views of an embodiment of a matrix block.

FIGS. 4A and 4B are two embodiments of damping elements.

FIG. 5 is a schematic side view of a double impact cutting machine.

FIG. 6 is a block diagram of the control means of an impact cutting machine.

FIG. 7A is a cross-sectional view by means of a further embodiment of the matrix block.

FIG. 7B is an entrance-sided view of the matrix block of FIG. 7A.

FIG. 7C is a top view onto the matrix block of FIG. 7A.

FIG. 8 is an entrance-sided view and a cross-sectional view of the moveable matrix element.

FIG. 9 is an entrance-sided view and a cross-sectional view of the stationary matrix element.

FIGS. 10A-10C are cross-sectional views of a further embodiment of a matrix block.

FIG. 11 is a further embodiment of a matrix having a variable cross-section.

FIG. 12 is a schematic view of the adjacent arrangement of three matrixes for a double separation.

FIG. 13 is a cross-sectional view of a further embodiment of the matrix block of FIG. 10A.

FIG. 14 shows clamping disks for the matrix block of FIG. 13.

### BEST MODE FOR CARRYING OUT THE INVENTION

Conventional impact cutters are optimized to separate a workpiece (mostly a specific basic material having a given thickness of wire-shaped material) by a very high impact rate so that many wire nails can be produced for further processing. When setting the machine, the system is optimized by tests in that on the one side a clear material separation is carried out and on the other side there is a preferably low transformation of the impact impulse into shock waves within the apparatus. The optimization time is justified by means of the subsequently long use of the machine with the optimized parameters. Such an optimization phase is however not justified for frequently changing workpiece types (form of material, thickness of material, used material etc.) or for irregularities as regards the nature of the material (defects of form, tolerances, location of the material in the cutting device, blowholes etc.).

Therefore it is desired on the one hand to achieve a change in the impulse of the impact element and the optimization of the impact energy in a manner as simple and reproducible as possible. Due to the dynamic processes in a pneumatic or hydraulic system this is very extensive and depends on the oil temperature, on the oil type, its contamination, the wear of sealing elements and the like. Further, in conventional impact cutters the moving impact element and the acceleration element are also connected to each other during the impact phase so that on the one hand the acceleration device has to be mechanically stable and on the other hand undergoes a strong mechanic stress, which leads to fast wear.

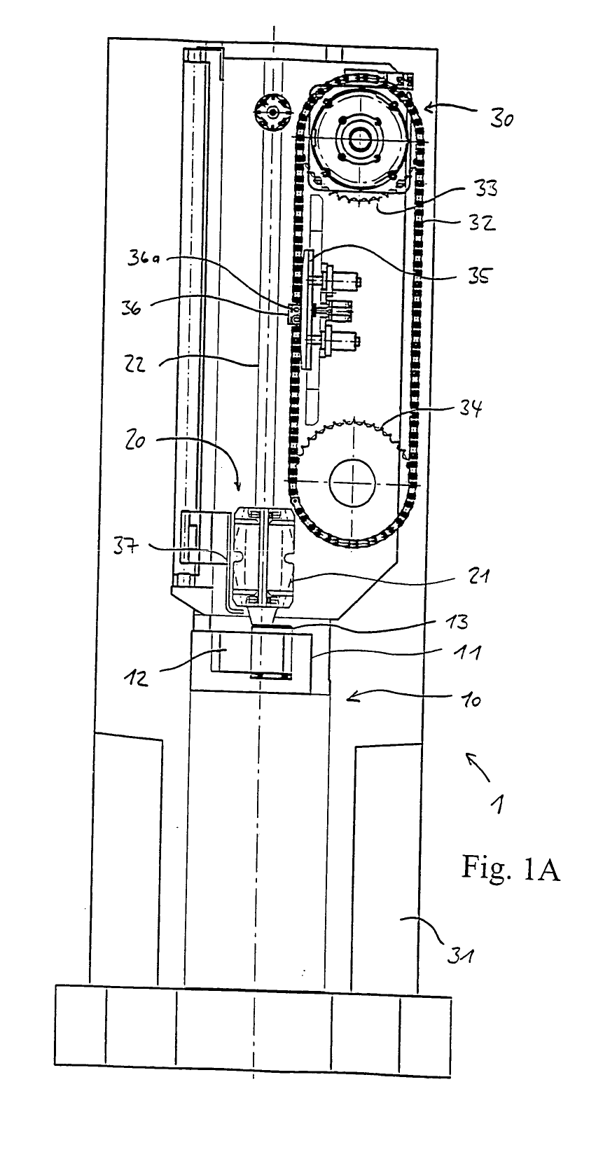

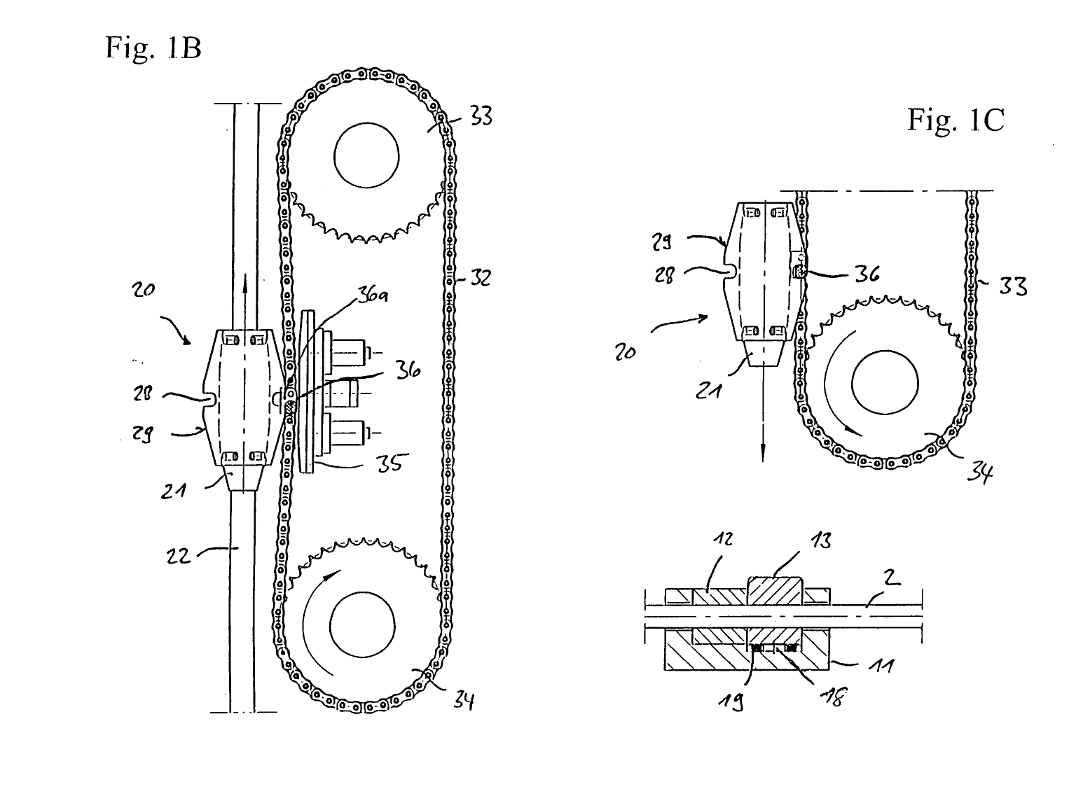

FIG. 1A schematically shows a front view of the construction of an impact cutting machine 1. The workpiece 2 to be cut (FIG. 1C) is clamped into a die or matrix block 10 and is cut there by carrying out impacts by means of the hammer unit 20. A percussion hammer 21 of the hammer unit 20 is accelerated by an acceleration unit 30. The matrix block 10 rests on a supporting structure 31 to which also a guiding 22 of the hammer unit 20 and the acceleration unit 30 is connected. Parts of the supporting structure 31 are formed of mineral cast which comprises besides the high supporting feature a particularly good damping against vibration and shock wave propagation. Vibration or shock wave propagation from the matrix block to the workhall floor or the acceleration unit 30 and the hammer 20 is therefore avoided. Vice versa, vibration propagation from the hammer unit 20 is highly damped.

In the acceleration unit 30 runs a chain 32 over an upper driving wheel 33 and a lower reversing wheel 34. The upper driving wheel 33 is driven by a NC-controlled servodrive 82 (FIG. 1D) which enables temporarily very high accelerations. The chain 32 carries a slide 36a from which protrudes a carrier 36 which in turn grips in a recess 28 of the hammer 21. A chain guiding 35 next to the chain 32 runs at least over a part of the acceleration distance. The chain guiding comprises an actuator, here a pneumatic actuator, which vertically positions to the chain a chain guiding rail running next to the chain. In the acceleration phase the chain guiding rail is positioned next to the chain (as shown in FIG. 1A) and limits or damps lateral chain deflections arising perpendicularly to the pulling direction, which could be evoked by the acceleration and the subsequent slowing down action, respectively. The contact surface of the chain guiding rail to the chain is provided with a sliding material.

For inserting the carrier 36 into the recess 28 during the coupling of the hammer 21, the chain guiding is pulled back so that the chain can be laterally deflected: FIG. 1B shows a partial view of the impact cutting machine in a phase on the verge of coupling the carrier 36 into the recess 28 of the hammer. After the impact the hammer 21 is lifted by a lifting unit 37 to the position shown in FIG. 1B after the impact and the slide 36a is driven upwards by means of the chain 33. FIG. 1C shows a phase during acceleration, while the carrier 36 completely grips into the recess 28 of the hammer 21.

In an embodiment not shown herein the chain 32 is alternatively or additionally driven by the lower wheel 34, so that the chain between the lower and the upper wheel 33, 34 is under tension and stiffened over the acceleration distance.

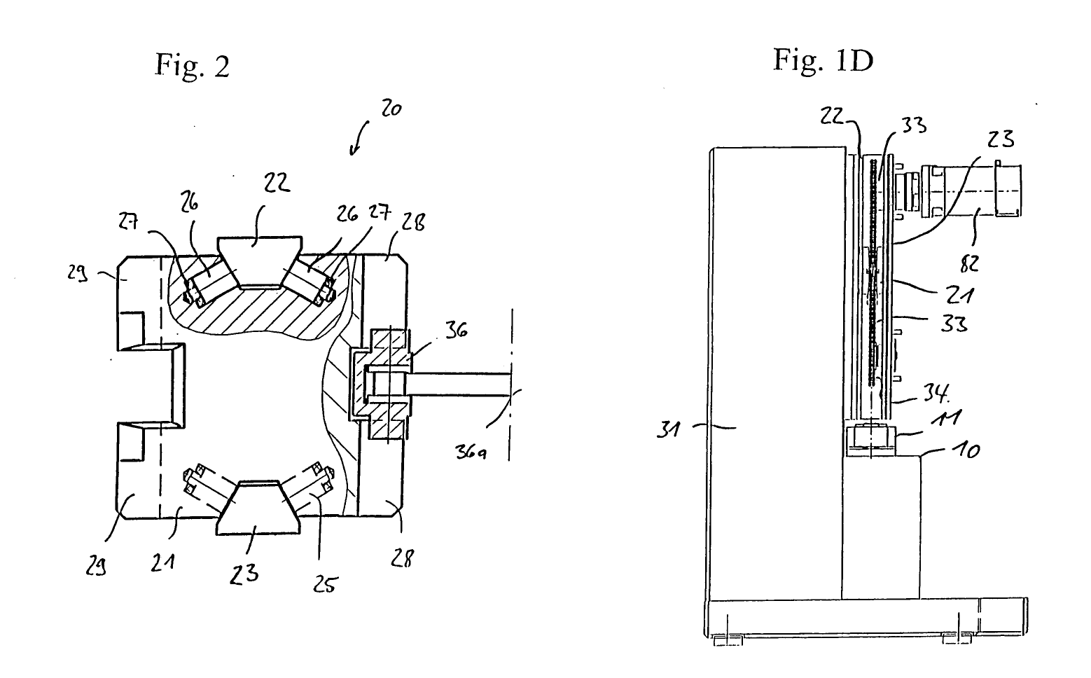

FIG. 2 shows a schematic cross-sectional top view of the above hammer unit 20. The hammer 21 is guided in a first and second guiding rail 23, 24 of the guiding 22. The hammer 21 does not directly contact the guiding rails 23, 24, but is slidingly driven on the rails 23, 24 via sliding blocks 26 resting in recesses 25. The sliding blocks 26 are for example metal matrixes in which molybdenum sulfide (MoS) is incorporated as lubricant. Between the back of the sliding blocks 26 and the bottom of the recess 25 damping elements 27 are arranged which transform impulses of the hammer 21 into heat and thereby damp the transmission of vibrations or shock waves from the hammer 21 to the rails 23, 24. In a further embodiment not shown herein, damping elements may also be associated to either all or a part of the sidewalls between the sliding block 26 and the recess 25. The carrier 36 of the acceleration unit 30 comprises lateral projections which are connected to the slide 36a via a connecting element. The two lateral projections of the carrier 36 grip into the two lateral recesses 28 of the hammer 21. Ramps 29 adjoin to the sidewalls of the recesses 28, wherein the projections of the carrier 36 slide over the ramp 29 when moving back the hammer 21 from the lower position (at the matrix block 10). The chain 32 and the slide 36a are deflected thereby (FIG. 1B) and after reaching the recess 28 the projections of the carrier 36 snap into the recess 28 so that the hammer 21 is lifted by the acceleration unit 30 and can be moved back into its starting position.

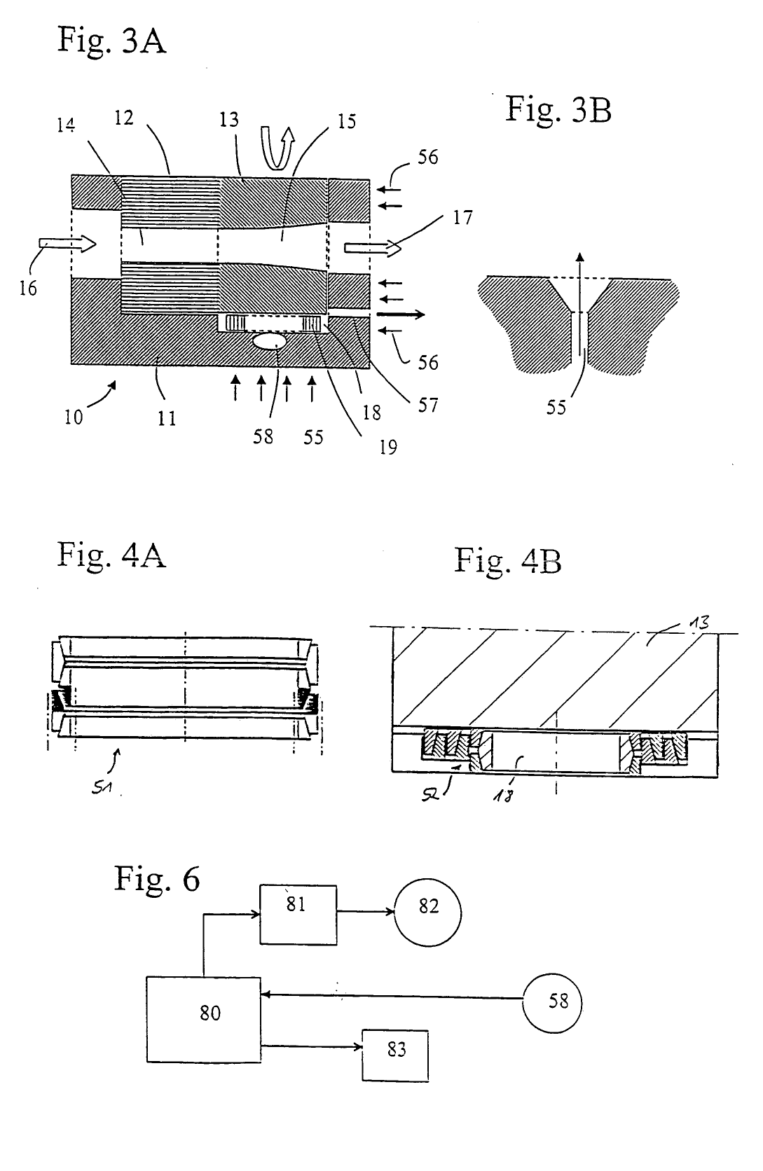

FIG. 3A is a cross-sectional view of a tool holder 11 of the matrix block 10. In a top down running recess of the tool holder 11 a stationary or fixed matrix 12 and a moveable matrix 13 are exchangeably inserted. The matrix pair 12, 13 has a first and a second passage 14, 15, wherein the cross-section of each is adapted to the workpiece to be processed. For cutting a workpiece of a different nature (cross-section, material of the workpiece, form of the workpiece etc.) the matrix pair 12, 13 is each exchanged in the tool holder 11. By means of mounting elements not shown the stationary matrix 12 is held fixedly in the tool holder 11, while below the moveable matrix 13 a recess 18 is arranged, which enables a little downward movement of the matrix 13 during the impact. The hammer 21 and/or the matrixes 12, 13 are formed of a particularly impact resistant steel, for example the product having the identification number 1-2379 (special steel) of the company STM-Stahl. The arrows 16 and 17 indicate the entrance side and the exit side of the workpiece 1 at the tool holder 11, wherein of course a reverse introducing and removing of the workpiece is also possible. The curved arrow symbolizes the performance of the impact to the moveable matrix 13.

The second passage 15 of the moveable matrix 13 opens from the intersection to the input and output 17, respectively. Thereby the workpiece is held free of clearance in the area of the cutting edge, while for longer workpieces a displacement of the end of the workpiece outside the matrix 13 is avoided during impact cutting. Thereby the mass to be accelerated is reduced during the impact and the required impulse energy for longer workpieces is widely independent from the length of the workpiece to be separated.

In the recess 18 a damping element 19 is arranged which absorbs the impact impulse or the part of the impact impulse, which has not been transformed into separation and deformation energy during the impact, and transforms it into heat. The damping element 19 countervails with very high power against the displacement of the moveable matrix 13, so that it is completely slowed down within a very short deflection distance, even if there is excessive energy. FIGS. 4A and 4B show two embodiments of the damping element 19. The first spring ring 51 is formed of five annular ring elements wedged into each other. The friction spring thereby formed transforms the displacement of the rings by friction into heat energy and causes an efficient damping of the moveable matrix 13. A second spring ring arrangement is indicated by reference numeral 52, in which the rings are partially positioned on top or below of each other, so that the base area of the recess 18 is further utilized.

After performing an impact onto the moveable matrix element 13 the retraction of the matrix 13 is carried out by the damping element 19. The retraction may alternatively or additionally be carried out by generating a pneumatic cussion below the moved matrix element 13, as shown in FIG. 3A. As symbolized by the arrows 55, compressed air is introduced into the recess 18, which discharges through an outlet 57 when the matrix element 13 is lifted. When the matrix element 13 is lowered the air outlet 57 is completely or partially closed so that due to the compressed air introduced through the lower pneumatic passages 55 in the recess 18 a pressure is generated, which re-lifts the matrix 13 in its starting position. The compressed air flow from the pneumatic passages 55 through the recess 18 prevents contaminations from penetrating into the recess 18 and cools the damping element 19 and the lower matrix side, respectively. In another embodiment air gaps are formed on at least one side wall between the tool holder 11 and the moveable matrix 13, into which air flows via lateral air passages 56. The compressed air between the moveable matrix and the tool holder 11 aligns the moveable matrix 13 and enables lateral sliding during the impact and afterwards a retraction of the moveable matrix 13 into the starting position.

In addition a sensor 58 is associated to the tool holder 11, which detects the vibrations of the tool holder 11 and/or measures the air pressure in the recess 18. Thus, the presence and the level of the vibrations can be measured while performing the impact. The level of the vibrations is a measurement for the excessive impact energy which has not been transformed for the separation of the workpiece. As excessive energy has to be preferably avoided, the signal of the sensor 58 is used for optimization of the parameters of the impact cutting machine as well as for controlling the function of impact cutting. As shown in FIG. 3A, if a pressure sensor associated to the recess 18 is used, also the proper retraction of the moveable matrix 13 can be checked while introducing compressed air into the recess 18, wherein after the retraction of the matrix 13 into the starting position the pressure within the recess 18 has to fall to a given value.

FIG. 3B shows an embodiment of a pneumatic passage 55 and/or 56, wherein several of these bores are provided in the tool holder 11 distributed over the surface area, so that a constant air cussion is formed. If a hole diameter of several micrometers (10-200 μm) is used, the compressed air can not discharge fast enough through the bores 55, 56 while compressing the air in the gaps or in the recess 18 and during deflection a high air pressure is formed in the gaps and/or the recess 18.

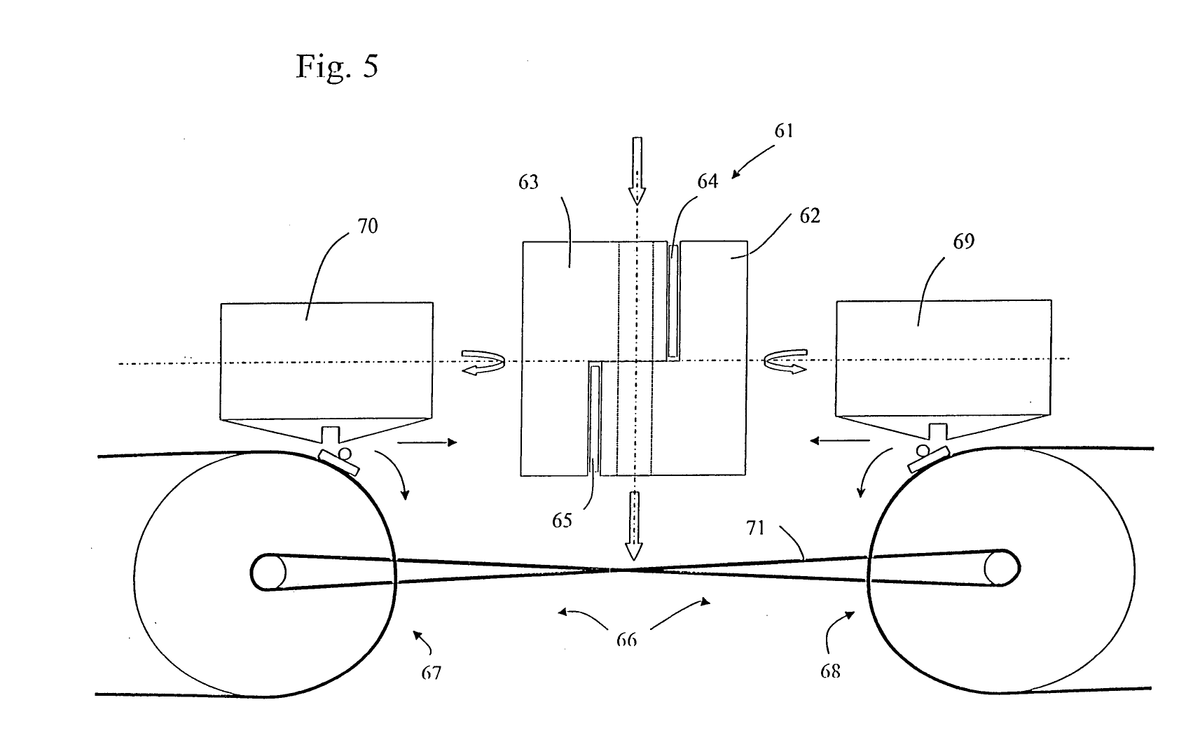

FIG. 5 schematically shows the arrangement of a double impact cutting machine 60. In this arrangement a cutting unit 61 is arranged floatingly or at least moveably in bi-directional impact direction in a tool holder not shown herein. A first and a second matrix 62, 63 are displaceable against each other and in respect of the tool holder. As shown in FIG. 5 the workpiece is introduced from above and the cutted parts are removed downward. The orientation herein is only exemplified. The matrixes 62, 63 are supported against each other over a first and a second damping element 64, 65. A first and a second hammer 69, 70 are preferably accelerated against each other on a common barycentric axis, wherein also the barycentric axis of the matrixes 62, 63 advantageously complies with that of the hammers 69, 70. An acceleration unit 66 accelerates the first and second hammer over a first and second acceleration distance 67, 68. The acceleration of the hammers 69, 70 is such that their impulses are equal. For an easier dimensioning and setting the weights of the hammers 69, 70 are preferably equal. By means of the belt 71 it is symbolically indicated that the acceleration over the first and second acceleration distance 67, 68 is carried out synchronously to each other. Thereby a common drive for example may be used which couples both acceleration distances via a gear, a chain or the like. The decoupling of the hammers 69, 70, the guiding of the hammers and/or the acceleration over the acceleration distances 67, 68 is advantageously carried out in accordance with the above embodiments in respect of the single acceleration distance of FIG. 1.

FIG. 6 schematically shows the control of the impact cutting machine 1 (or 61+66) by means of a control unit 80. Operation parameters, such as the type of the matrix and the material to be cut, are input into the control unit, so that it is possible to access given sets of parameters each including a standard setting in accordance with the matrixes and the material to be cut. The control unit 80 activates a power controller 81 providing the electrical power for driving a motor 82 which for example drives the upper driving wheel 33. The control unit 80 thereby sets the starting position for the acceleration of the hammer 21 and controls the level of acceleration (where applicable temporally variable over the acceleration distance), where applicable the end point of the acceleration (so that already before decoupling a relaxation between the hammer 21 and carrier 36 arises) and the moving back of the carrier for retracting the hammer 21 in its starting position for the next impact operation. Further, by means of the control unit 80 a transport unit 83 is activated which causes the feeding of the output material to be cut into the tool holder 11. For optimizing the impact process the sensor signal of the sensor 58 is fed to the control unit 80, so that by means of the excessive energy level (see above) the control unit can optimize the process by setting the acceleration parameters until the excessive energy is minimal.

The acceleration of the hammer 21 (the same applies for the hammers 69, 70) is carried out in that the hammer or carrier 36 is in the starting position and the acceleration operation starts by means of the motor 82. Thereby also with small required impact impulses (for example with a thin workpiece) it is possible to start from a maximal retraction position in order to be able to accelerate over a long acceleration distance with low acceleration power.

If however a high impact frequency is required, an acceleration distance as short as possible (low starting position of the hammer 21) is chosen in accordance with the required impact impulse, so that the acceleration and retraction operation can be carried out in a short time. Thereby a high acceleration acts then on the hammer.

On the level of the lower reversing wheel the reversing of the chain 32 causes the slide 36a being pulled back and thus the carrier 36 being pulled out of the recess 28 (e.g. FIG. 5). Just after a short deflection of the slide 36a (small pivoting angle at the reversing wheel 34) the carrier 36 is pulled out of the recess 28 and the movement of the hammer 21 unimpededly continues towards the matrix block 10. For lifting the hammer 21 into the starting position the hammer 21 is, after performing the impact by the lifting mechanism 37 shown in FIG. 1A, either synchronously lifted when retracting the carrier 36, so that by lifting the hammer 21 and by moving up the carrier 36 the carrier grips into the recess 28, or the hammer 21 is lifted by the lifting mechanism to a level above the lower reversing wheel 34, so that the projections of the carrier 36 slide over the ramp 29 and by pushing apart the chain 32 (phase FIG. 1B) the projections of the carrier snap into the recess 28 behind the ramp. As mentioned above, in this phase the chain guiding rail is pulled back from the base line of the chain 32 by means of the actuator of the chain guiding 35. After the carrier 36 snapped into the recess 28, the hammer 21 can be moved back into the starting position by means of the acceleration unit 30.

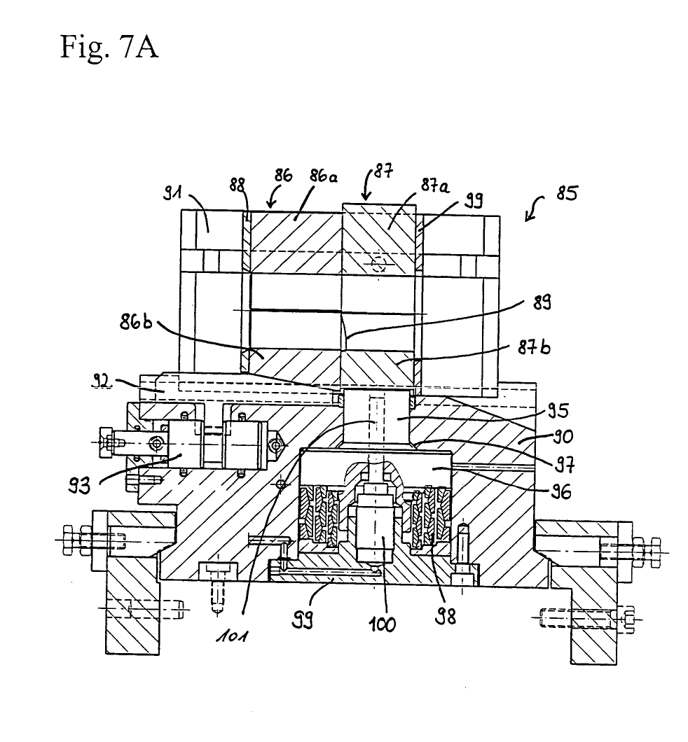

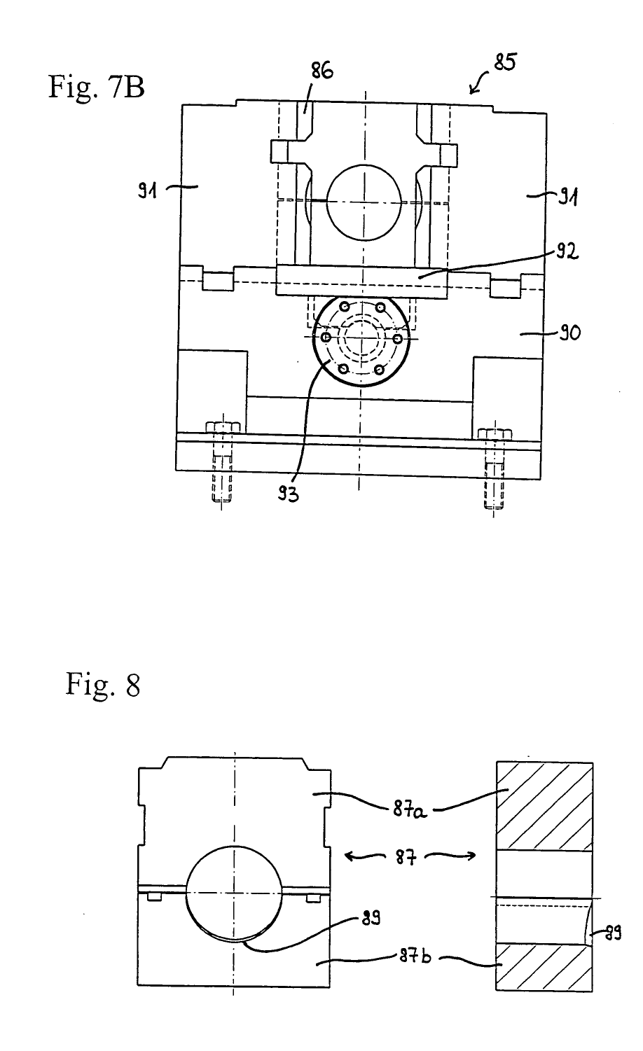

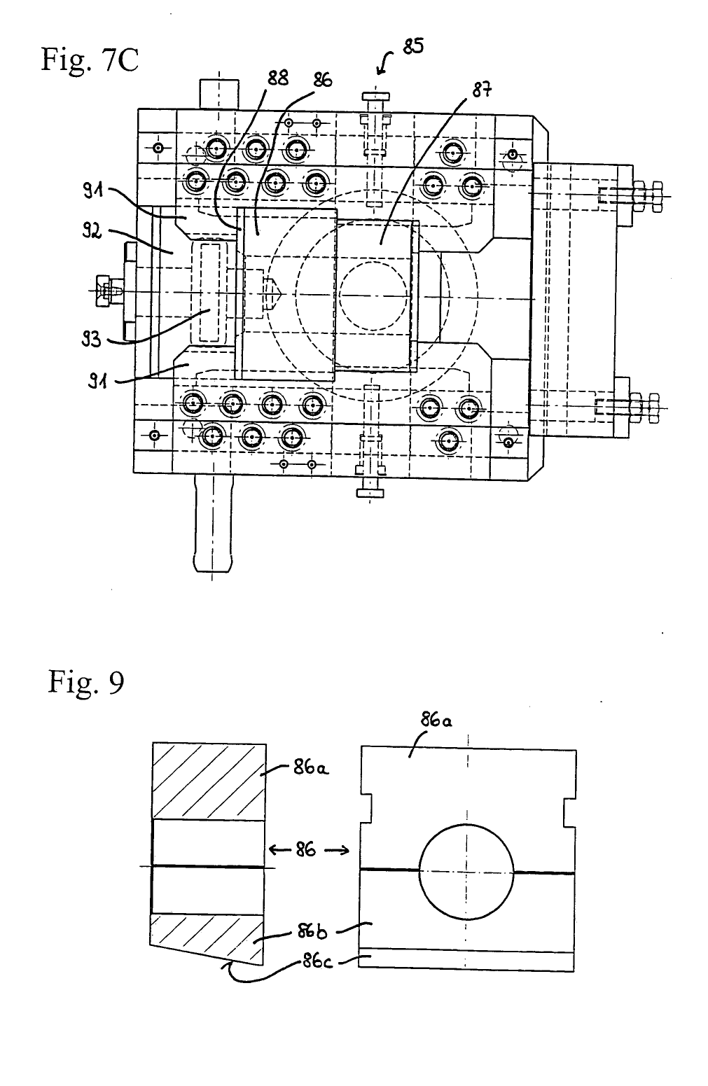

FIG. 7A shows a modification of the matrix block 10 shown in FIG. 3A. The matrix block 85 comprises a two-part stationary matrix 86 and a two-part moveable matrix 87. The matrixes 86, 87 are divided in the plane perpendicular to the drawing plane into an upper and a lower part 86a, 86b of the stationary matrix 86 and an upper and a lower part 87a, 87b of the moveable matrix 87. In contrast to the standard cross-sectional measurement of the matrixes 86, 87 the separation groove between both parts 86a, 87a and 86b, 87b is chosen in such a manner that, even if the workpiece is of undermeasurement, those still abut on the top and bottom surface of the workpiece inserted into the matrixes 86, 87 (viewed in impact direction, which runs top down in the drawing plane of FIG. 7A). An adaptation plate 88 having a conical entrance opening is arranged in front of the stationary matrix 86 in feeding direction (from the left), so that while automatically feeding forward, the workpiece to be separated is reliably fed into the moveable matrix. At the entrance side the moveable matrix 87 has a phase 89 on the lower part 87b, so that also inserting the workpiece coming from the stationary matrix 86 is also facilitated. The matrixes are supported on a base plate 90 which in turn is clawed onto a base of the impact machine, as for example shown in FIG. 1A. The matrixes are held between the matrix jaws 91 (see also top view of FIG. 7C) and are exchangeable within the matrix block 85, so that an adaptation to varied cross-sections of the workpiece is ensured.

The adjustment of the cross-section of the stationary matrix 86 is carried out by means of a wedge 92 displaceable in tool transport direction, the wedge being displaced by a displacement unit 93. The wedge 92 interacts with a lower ramp-shaped surface 86c (see FIG. 9) of the lower part 86b of the matrix, so that by displacing the wedge 92 the lower matrix part 86b is lowered or lifted. The displacement direction of the wedge 92 herein is only exemplified and the lifting or lowering of the lower matrix part 86b or the upper matrix part 86a may also be carried out in another manner by means of an adjustment element. For inserting or transporting the workpiece to be processed the wedge 92 is pulled back to the left in the shown embodiment, so that the lower matrix part 86b is lowering downward. Thus the cross-section opens in impact direction of the stationary matrix 86 and the diplaceability of the workpiece in the cross-section of the opening is given. After positioning the workpiece, the wedge 92 is re-displaced to the right, so that a clamping of the workpiece at the top and at the bottom results.

The moveable matrix 87 rests on a damping piston 95 which in turn rests via a support or distribution plate 96 on the spring ring arrangement 98 as a damping element. The spring ring arrangement 98 comprises here three concentric circles of spring ring sets each having a different number of individual spring ring elements. The spring ring arrangement 98 rests on a pressure plate 99 which in turn is screwed from the bottom onto the base plate 90. While screwing the pressure plate 99 the spring ring arrangement 98 is compressed between the pressure plate 99 and the base plate 90 and a biasing power given by the compression distance is set. Here the spring ring arrangement 98 is compressed between the pressure plate 99 and the stop unit 97 at the bottom of the damping piston 95. If an impact is carried out on the upper surface of the upper matrix part 87a, the workpiece is initially clamped between the upper and lower matrix parts 87a, 87b until a counter force corresponding to the bias of the spring ring arrangement 98 is build up, thereafter the moveable matrix 87 then moves downward with the clamped workpiece.

A hydraulic cylinder 100 arranged below the moveable matrix 87 lifts the moveable matrix until it abuts on a stop unit (not shown) and is aligned with the stationary matrix 86 in this lifted position, i.e. the openings in the matrixes 86, 87 for retaining the workpiece to be separated are positioned in parallel congruent with each other. After carrying out the separation impact, the matrix 87 is thus retracted to the starting position by means of the cylinder 100. A piston rod 101 operated by the cylinder 100 is fed through a bore into the support plate 96 and directly abuts on the bottom surface of the moveable matrix 87 after lifting the rod 101. During the separation impact the piston rod 101 is usually retracted. In another embodiment the hydraulic cylinder 100 acts via the piston rod on the support plate 96 either for lifting the matrix 87 or for biasing the matrix 87 during the impact. Thereby the hydraulic cylinder 100 supports the damping of the deflection of the moveable matrix 87.

FIGS. 7C and 7B show a top view onto the matrix block 85 and an entrance-sided view. FIG. 8 shows an entrance-sided view of the two-part moveable matrix 87 and FIG. 9 shows an entrance-sided view and a cross-sectional view of the stationary matrix 86.

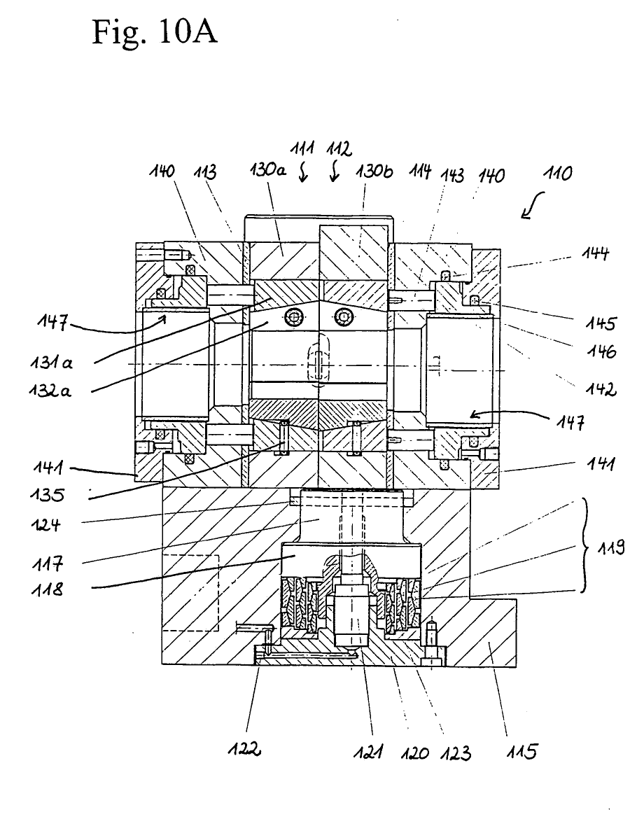

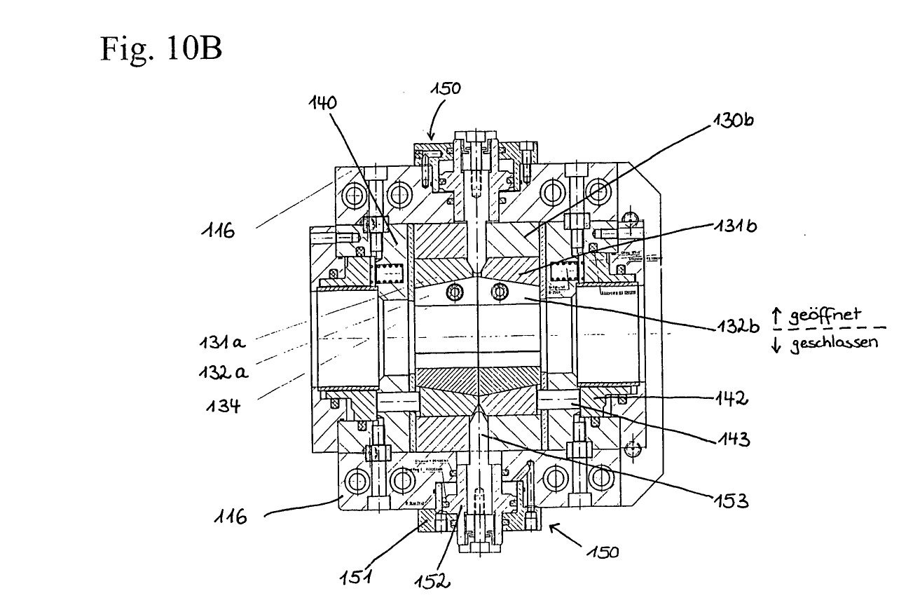

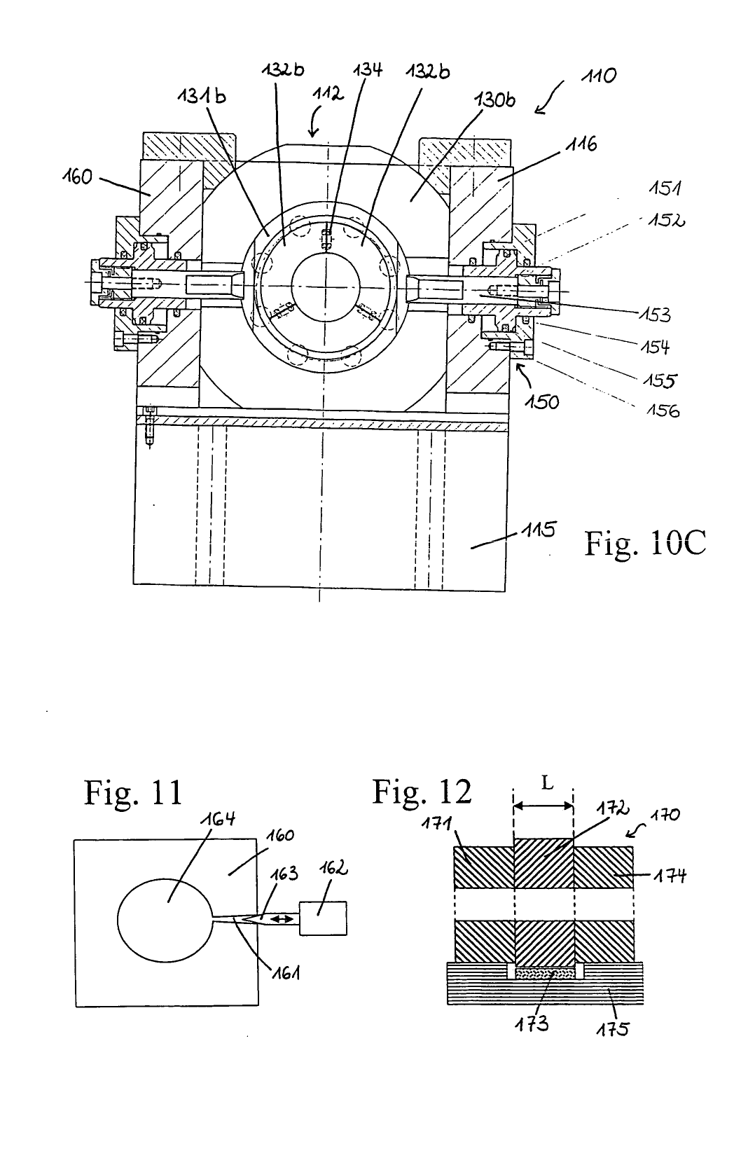

FIGS. 10A to 10C show cross-sectional views in different directions of a further embodiment of a matrix block 110. FIG. 10A shows a lateral cross-sectional view 10a by an axis running along the forward feed of the workpiece to be separated, FIG. 10B shows a cross-sectional view in top view and FIG. 10C shows a lateral cross-sectional view in the plane, in which a stationary matrix 111 and a moveable matrix 112 of the matrix block 110 abut on each other. As regards the basic construction, the matrix block 110 complies with the matrix blocks 10 and 85 shown in FIGS. 3A and 7A. Thus only deviating elements or arrangements are described in detail below, while the elements already known from previously described matrix blocks are only explained in short version. In the arrangement shown in FIG. 10A the rod material to be separated enters from the left into the opening of the matrix block 110, wherein beginning from the left a left front plate 140, an adaptation plate 113, the stationary matrix 111, the moveable matrix 112, a pressure plate 114 and the right front plate 140 are arranged. As regards the function of the adaptation plate 113 and the pressure plate 114, it is referred to the corresponding elements 88 and 99 of FIG. 7A. The matrixes 111, 112 are laterally supported by matrix jaws 116 (top view of FIG. 10B). In a base block 115 a damping piston 117, a support plate 118, a spring ring arrangement 119, a pressure plate 120, a hydraulic cylinder 121, a hydraulic feed line 122 for operating the cylinder 121 and a stepped plate 123 for supporting the spring rings 119 of different sizes as well as a guiding ring 124 are arranged. As regards the function of the elements 117 to 124, it is referred to the corresponding function of the elements 95 to 100 of the matrix block 85 (FIG. 7A).

For clamping the rod material in the openings of the matrixes 111 and 112 these have a slightly variable cross-section of openings. The stationary matrix 111 is thereby composed of a first inner ring 131 which is inserted into a first outer ring 130a. In the first inner ring 131a in turn three inner segments 132a are arranged, compare lateral view of the corresponding inner segments 132b of the moveable matrix 112 in FIG. 10C. The moveable matrix 112 is correspondingly composed of a second outer ring 130b having a second inner ring 131b inside and the inner segments 132b. In the assembled state three inner segments 132a, 132b form in turn a ring divided by a gap respectively, wherein O-rings 134 are inserted into each gap between the inner segments 132a, 132b. The O-rings serve on the one hand for aligning the segments to each other while mounting and on the other hand for pressing apart the inner segments 132a, 132b, if these are released on their perimeter from the first and second inner ring 131a and 131b, respectively (see below).

The first and the second inner ring 131a, 131b are respectively arranged between the first and second outer ring 130a, 130b and the inner segments 132a, 132b and are displaceable in axial direction. The outer surface of the inner ring 131a, 131b forms together with the inner surface of the outer ring 130a, 130b a guiding surface axially running in parallel for axial displacement. The inner surface of the inner ring 131a, 131b has a ramp-formed shape in respect of the outer surface of the inner segments 132a, 132b, so that when axially displacing the inner ring, the inner segments 132a, 132b are clamp-likely shifted together or released in radial direction. Referring to FIG. 10A, a displacement of the inner ring 131a to the right results in pressing the inner segments 132a together, so that the cross-section of the opening for retaining the rod material to be cut is reduced. In the moveable matrix 112 a displacement of the second inner ring 131b to the left results in pressing the inner segments 132b together while reducing the cross-section of the opening. When the cross-section of the opening is expanded, that is to say when releasing the clamped rod material, the first inner ring 131a is displaced to the left and the O-rings 134 between the inner segments 132a press the inner segments apart. Vice versa, when opening the moveable matrix 112, the wedge-shaped second inner ring 131b is displaced to the right, wherein the O-rings 134 press the inner segments 132b apart. By means of a rotary protection ring 135 the inner ring 131a, 131b and the lowest of the inner segments 132a, 132b are secured against rotation on the outer ring 130a, 130b.

For axially displacing the first inner ring 131a in clamping direction (to the right) and the second inner ring 131b in clamping direction (to the left), respectively, one clamping hydraulic system 147 each is arranged between the front plate 140 and a cap 141. A pushing piston 142 is hydraulically displaced in axial direction between the front plate 140, the cap 141 and an inner sleeve 146. On the inner surface of the pushing piston 142 several pushing pins 143 are distributed and arranged over the perimeter of the inner rings 131a, 131b (8 units along the perimeter, as can be seen in FIG. 10C), which abut on the outer side surface of the inner rings 131a, 131b and displace these to right (stationary matrix 111) and to the left (moveable matrix 112). By pressurization from behind the pushing piston 142 is displaced forward (towards the inside of the matrix block 110) for clamping. For releasing the clamping the piston is back-sidedly de-pressurized and pushed apart towards the top 141 by means of the inner rings 131a, b. The sealing of the pushing piston 142 between the cap 141 and the front plate 140 is established by means of sealing units 144, 145. In a further embodiment not shown the piston 142 may be pushed forward and backward by hydraulic operation from both sides.

As can be seen from FIGS. 10B and 10C one reset or retracting hydraulic system 150 is respectively laterally arranged on both sides of the matrix block for releasing a clamped workpiece. In the side jaws 116 of the matrix block 110 cylindrical elements 151 are inserted, in which one piston 152 each may hydraulically be operated forward or backward. A reset spike 153 is inserted into the piston 152, which passes through the two outer rings 130a, 130b and extends into a wedge-shaped recess on the outer edge between the inner segments 132a, 132b. By pushing the piston 152 forward the wedge-shaped tip of the reset spike 153 slides into the triangular groove between the first and second inner ring 131a, 131b and pushes the inner rings apart. For releasing the clamping of the workpiece in the openings of the matrixes 111, 112 the reset spike 153 is thus moved forward and the first inner ring 131a is displaced to the left (FIG. 10A) and the second inner ring 131b to the right, which causes that the released segments 132a, 132b increase the cross-section of the opening. The piston 152 is displaceably supported and sealed in the cylindrical element 151 by means of sealing units 154, 155, 156. After releasing the clamping the reset spike 153 is moved back by means of counter pressure exerted to the piston 152, so that after feeding the workpiece forward it may be re-clamped by the clamping hydraulic system(s) 147.

In the top view of FIG. 10B the matrix block 110 is shown in the upper half in opened position, while in the lower half of the drawing it is shown in closed position. In FIG. 10A the moveable matrix 112 is shown in opened position, while the stationary matrix 111 is shown in clamped position.

FIG. 11 schematically shows a further embodiment of a matrix 160, which is arranged in the matrix block 85 and 110 instead of the stationary matrixes 86, 111 and/or the moveable matrixes 87, 112 and which also comprises a variable cross-section. The matrix 160 surrounds the opening 164 for retaining the workpiece on the entire perimeter except of a little gap 161 preferably running radially. On the outside the gap runs conically, so that an expanding spike 163 can be moved into or out of the gap by means of a hydraulic unit 162. By moving the expanding spike inward or outward the gap dimension is variable, so that the cross-section of the opening 164 may be slightly varied. The gap and the cross-section of the opening is advantageously formed in such a manner that, when the expanding spike 163 is moved back, the matrix clamps a workpiece being within the opening 164, even if for example due production tolerances of the workpiece a lower limit of the cross-section of the workpiece is reached. While performing the impact onto the moveable matrix, the expanding spike 163 is advantageously retracted entirely from the gap 161. Thus the matrix 160 is in clamping position and in the case of the moveable matrix no reaction coupling is carried out between the matrix movement and the hydraulic unit 162. For axially feeding the workpiece or the rod material forward the expanding spike 163 is initially moved into the gap 161 as far as a clamp-free forward feed in axial direction is enabled, even if upper production tolerances of the cross-section of the workpiece or the rod material are reached. After feeding the rod material forward the expanding spike 163 is again pulled back out of the gap 161. In a further embodiment not shown herein, the upper and lower half of a matrix confining the gap 161 are connected to an operating unit in such a manner that the gap width of the gap 161 may be expanded and/or narrowed compared to the unbiased state. By means of the operating unit also during the performance of the separation impact an additional clamping force is transmitted by narrowing the gap width at the matrix 160.

FIG. 12 shows a schematic cross-sectional view of a successive arrangement 170 of three matrix elements 171, 172, 173. Between a first stationary matrix 171 and a second stationary matrix 174 a moveable matrix 172 is arranged. A damping element 173 is arranged in impact direction between the moveable matrix 173 and a base block 175. The damping element 173 may be formed corresponding to the damping elements described in the other embodiments. Further, one, more or all matrixes 171, 172 and 174 may be formed having an variable cross-section in accordance with the embodiments in FIG. 7A, 10A or 11—correspondingly one, more or all matrixes may comprise a fix cross-section. The matrix arrangement 170 is particularly suitable for cutting rod material, if rod material having identical and relatively short length L is to be repeatedly cut. Thereby, the depth of the moveable matrix 172 is formed corresponding to the desired length L of the workpiece. During the feeding the rod material is forwarded each by the forward feed length 2L, so that, after the separation of the rod material, at the edge between the first stationary matrix 171 and the moveable matrix 172 as well as at the edge between the moveable matrix 172 and the second stationary matrix 174 two workpieces each having the length L are cut off. By means of the symmetry as regards the separation a balanced load of the tool and the matrix block is achieved during the separation impact, so that the matrix block can be dimensioned smaller and the wear of the matrix block is smaller.

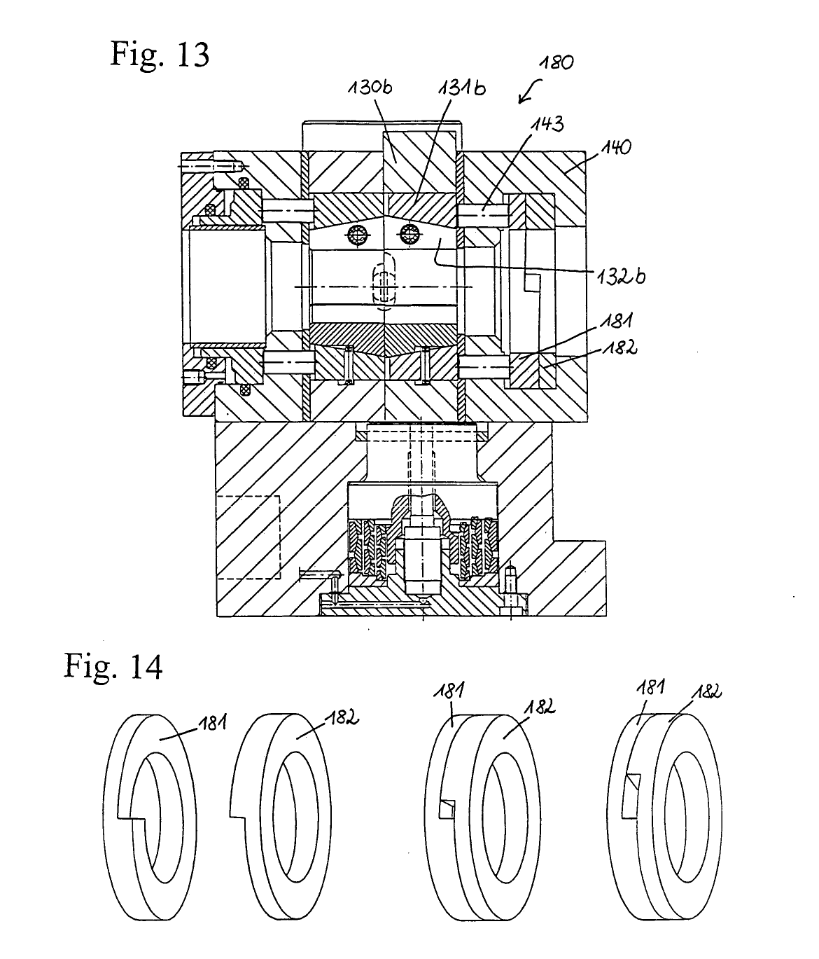

FIG. 13 shows a matrix block 180 being a modification of the matrix block 110 of FIG. 10A. Apart from the clamping discs 181, 182 which replace the clamping hydraulic system 140-147 on the right of FIG. 10A, all elements are identical to those of matrix block 110 and are thus not described in more detail. In the right front plate 140 of the matrix block 180 clamping disks 181 and 182 are arranged, the non-opposing front surfaces of which are planar. The left front surface of the first clamping disk 181 acts on the bronze pins 143 and the right front surface of the second clamping disk 182 abuts on the front plate 140. The opposing front surfaces of the clamping disks 181, 182 comprise helical or spiral-shaped supporting surfaces being paired to each other. As shown in the two drawings on the right of FIG. 14, the axial dimensions of the two abutting clamping disks changes, if these are positioned at different rotational angles. The clamping disks can be rotated relative to each other up to a given angle (less than 150°), while the outer front surfaces are in parallel to each other and the left front surface of the first clamping disk 181 synchronously displaces the pins 143 to the left. The pins 143 act in turn on the second inner ring 131b which thereby displaces the inner segments 132b inwards (see above as regards the clamping of a workpiece at the matrix block 110).

Similar to the operation of the clamping hydraulic system 140-147 on the right of FIG. 10A a clamping of the workpiece is achieved by rotating the first clamping disk 181 to the left (looking in the drawing plane of FIG. 14 from the left in axial direction), while by means of a rotation to the right the clamping of the workpiece is released. The same applies, if the second clamping disk 182 is rotated instead of the first clamping disk 181. An operating device for rotating the right or left clamping disk is provided, but not further explained herein.

The above explained matrix blocks for the use in an impact cutting machine are advantageously arranged on a supporting structure of mineral cast in order to damp the transmission of shockwaves.

1. A cutting unit for an impact cutting device having at least one first and one second matrix element for retaining a workpiece to be processed, wherein
at least one of the matrix elements is moveably supported relatively to at least one of the other matrix elements wherein the at least one of the matrix elements has a variable cross-section for retaining the workpiece.

2. The cutting unit according to claim 1, characterized in that one of the matrix elements comprises a structure of at least two parts.

3. The cutting unit according to claim 1 further comprising clamping devices for reducing the cross-section of the workpiece retaining area.

4. The cutting unit according to claim 3, characterized by a reset device for releasing the clamping caused by the clamping device.

5. The cutting device according to claim 1 characterized in that the variable opening for retaining the workpiece is defined by at least two inner segments.

6. The cutting unit according to claim 5, characterized in that the inner segments are formed as partial segments of a ring.

7. The cutting unit according to claim 6, characterized in that the inner segments are surrounded by a setting ring wherein the inner segments and the setting ring are coupled to each other via a transformation device, so that the cross-section of the opening surrounded by the inner segments is adjustable by axially displacing the setting ring.

8. The cutting unit according to claim 1 characterized in that the at least one of the moveable matrix elements has at least partially phased entrance opening.

9. The cutting unit according to claim 1 characterized in that a damping element is arranged between the at least one of the other matrix elements and the at least one moveable matrix element opposite to an impinging side of the moveable matrix element.

10. The cutting unit according to claim 9, characterized in that the damping element is biased in an impact direction.

11. The cutting unit according to claim 9 characterized in that the damping element comprises at least one ring spring.

12. The cutting unit according to claim 1 characterized in that the variable cross-section has a value range so that in case of a workpiece to be processed having a minimal width due to production tolerances can be clamped in the retaining opening of the matrix and that in case of a workpiece having maximum cross-section due to production tolerances a forward feed of the workpiece to be processed is enabled at maximum width.

13. An impact cutting device having a cutting unit according to claim 1 further comprising an acceleration unit and an impact element for accelerating against the acceleration unit.

14. The impact cutting device according to claim 13, characterized in that the impact element and the acceleration unit are releaseably coupled, wherein the impact element is arranged to be decoupled from the acceleration unit after the acceleration by the acceleration unit and prior to impinging onto the cutting unit.

15. The impact cutting device according to claim 13 characterized in that the acceleration of the acceleration unit is adjustable.

16. In an impact cutting device, the improvement comprising,
a matrix element for retaining a workpiece to be processed in the impact cutting device wherein the matrix element has a variable cross-section for retaining the workpiece.

17. In an impact cutting device, the improvement comprising,
a cutting unit having two matrix elements for retaining a workpiece to be processed, wherein at least one of the matrix elements is moveably supported relatively to the other matrix element, particularly with at least one matrix element having a variable cross-section for retaining the workpiece wherein a damping element is arranged between a support and the at least one moveable matrix element opposite to the impinging side of the moveable matrix element.
